(19) United States
(12) Patent Application Publication
(10) Pub. No.: US 2025/0176600 A1
(43) Pub. Date: Jun. 5, 2025

(54) METHOD FOR PRODUCING THERMALLY MODIFIED STARCH BLENDS

(71) Applicant: ROQUETTE FRERES, Lestrem (FR)

(72) Inventors: Solène BOCK, LAMBERSART (FR); Jacques LEGRAND, VERQUIN (FR)

(21) Appl. No.: 18/729,394

(22) PCT Filed: Jan. 18, 2023
(86) PCT No.: PCT/EP2023/025015

§ 371 Date: Feb. 10, 2025

(30) Foreign Application Priority Data
Jan. 21, 2022 (FR) FR2200521

(51) Int. Cl. A23L 29/212; C08L 3/02

(52) U.S. Cl. CPC A23L 29/212; C08L 3/02

(57) ABSTRACT

A method for preparing a blend of at least two heat-modified starches, in which the starches are granular starches of different botanical origins, which comprises the steps consisting in: (i) preparing a starch milk containing at least two starches of different botanical origins, having total dry matter content comprised between 30 and 40%, and preferably between 35 and 37% by weight, (ii) preparing a citrate buffer with a pH between 4 and 6, preferably 6, and adding said citrate buffer to the starch milk so as to obtain a milk pH between 4 and 6, preferably 6, (iii) ensuring a contact time comprised between 0.5 and 5 hours, (iv) drying until reaching an equilibrium moisture content of 10 to 12%, (v) heating over 150° C., for a residence time of between 10 minutes and 6 hours, (vi) resuspending, adjusting the pH, optionally washing and again drying the heat-modified starches thus obtained.

The invention relates to a method for producing a blend of at least two heat-modified starches, in which the starches are granular starches of different botanical origins, this method involving blending said starches of different botanical origins under acidic conditions before performing the actual thermal treatment.

Acidic conditions are defined as the treatment of a blend of at least two starches of different botanical nature, in the milk phase, with a citrate buffer at a pH of between 4 and 6.

More particularly, the invention relates to a method for producing a blend of heat-modified potato starch and waxy corn starch.

Such blends of at least two heat-modified starches make it possible to reinforce their viscosity properties while retaining the texturizing properties expressed by the heat-modified starches prepared from a starch derived from a single botanical origin.

Such heat-modified starches then have a use as thickeners and texturizing agents in numerous food applications, mainly in soups and sauces, and in dairy products.

### FIELD OF THE INVENTION

Synthesized biochemically, a source of carbohydrates, starch is one of the most widespread organic materials in the plant kingdom, where it constitutes organisms' nutrient reserves.

Starches have always been used in the food industry, not only as a nutritional ingredient but also for their technical properties, as a thickening agent, binder, stabilizer or gelling agent.

For example, native starches are used in preparations requiring cooking. Corn starch, especially, forms the basis of “powders for flan”.

Since it is rich in amylose, it retrogrades and therefore gels strongly. It makes it possible to obtain firm flans after cooking and cooling.

It is also suitable for custards.

However, these cannot be used in pastries intended to be frozen since, on defrosting, the phenomenon of syneresis, which is reflected in the expulsion of water, destroys the texture of the custard.

Thus, in its native state, starch has limited applicability due to syneresis, but also due to:
its low resistance to shear stresses and to heat treatments,
its high retrogradation,
its limited processability, and
its low solubility in common organic solvents.

Thus, in order to meet today's demanding technical requirements, the properties of starch have to be optimized by various methods known as “modification”.

These main modifications therefore aim to adapt the starch to the technical constraints resulting from cooking, but also from freezing/thawing, from appertization or sterilization, and to make it compatible with modern food (microwaves, instant meals, “high temperatures”, etc.).

Starch modification therefore aims to correct one or more of the abovementioned defects, thereby improving its versatility and meeting the needs of consumers.

Techniques for modifying starch have generally been classified into four categories: physical, chemical, enzymatic and genetic, the ultimate goal being to produce various derivatives with optimized physicochemical properties.

Chemical and physical modifications are most commonly implemented.

Chemical treatment consists of introducing functional groups into the starch, which alters its physicochemical properties in a noteworthy manner. Indeed, such modifications of granular native starches profoundly alter their behavior in terms of gelatinization, bonding and retrogradation.

Generally, these modifications are made by chemical derivatization, such as esterification, etherification, crosslinking or grafting.

However, chemical modifications are less sought-after by consumers in food applications (also for environmental reasons), even if some modifications are considered to be safe.

Various physical modifications are thus proposed, for example:
heat moisture treatment (HMT), consisting of treating the starch at controlled moisture levels (22-27%) and at high temperature, for 16 hours, in order to alter the structure and physicochemical properties of the starch;
annealing, consisting of treating the starch in an excess of water at temperatures below the gelatinization temperature, in order to come close to the glass transition temperature;
high-pressure processing (HPP), by means of which the amorphous regions of the starch granule are hydrated, leading to a distortion of the crystalline parts of the granule and promoting the accessibility of said crystalline regions to water;
glow discharge plasma treatment, which generates, at ambient temperature, high-energy electrons and other highly active species. Applied to the starch, these active species excite the chemical groups in the starch and cause significant crosslinking of the macromolecules;
osmotic pressure treatment (OPT), carried out in the presence of solutions with a high content of salts. The starch is suspended in sodium sulfate in order to produce a uniform suspension.

The starch goes from type B to type A after treatment, thereby acquiring a gelatinization temperature which increases significantly;
“thermal inhibition” treatment. Generally, thermal inhibition means dehydrating a starch until it reaches the anhydrous or substantially anhydrous state (i.e. <1% moisture content), then a thermal treatment at more than 100° C. for a sufficient period of time to “inhibit” the starch, in this case to afford it properties of crosslinked starches. Moreover, it is necessary to place the starch under pH conditions which are at least neutral to preferentially alkaline, before carrying out the step of forced dehydration.

An alternative to “thermal inhibition” treatment has been proposed in the solvent phase and consists of heating a non-pre-gelatinized granular starch in an alcohol-based medium in the presence of a base and salts at a temperature of 120 to 200° C. for 5 minutes to 2 hours.

Regardless, the thermal inhibition process thus leads to obtaining a starch paste having properties of increased resistance to viscosity breakdown, and a non-cohesive texture.

The technical field to which the invention belongs is that of thermal inhibition treatment of starch without an aqueous-alcoholic solvent.

In this particular technical field, mention may more particularly be made of U.S. Pat. No. 6,221,420, which describes a thermally inhibited starch obtained by dehydration then thermal treatment.

The main steps are:
dehydration of the starch to a water content of less than 1%, carried out at a temperature comprised between 10° and 125° C., then
heat treatment of the dry starch thus obtained, at approximately 140° C., in a reactive fluidized bed, for a duration of the order of 20 hours.

Preferentially, before the step of dehydrating the starch, it is recommended to perform a step of alkalinization of the starch, making it possible to bring the pH of the starch suspension to a value comprised between 7 and 10, preferably comprised between 8 and 10.

At this stage, before the step of dehydration proper which precedes the inhibition step, the water content of the starch (as demonstrated by way of examples) is then comprised between 8 and 10%.

Patent application US 2001/0017133 describes a similar method, wherein the starch is also dehydrated below 125° C. before the inhibition process is begun (at a temperature higher than 100° C., preferentially comprised between 12° and 180° C., more preferentially comprised between 14° and 160° C.) for a duration of up to 20 hours, preferentially comprised between 3:30 hours and 4:30 hours.

Before the dehydration step, the conventional alkalinization step leads to a starch suspension having a pH value comprised between 7.5 and 11.2, preferably comprised between 8 and 9.5%, and a water content comprised between 2 and 15%.

A variant was proposed in patent application WO 2014/042537, said variant relating to heating an alkaline starch to temperatures comprised between 14° and 190° C. while ensuring that the inhibition method is initiated and carried out in the presence of a sufficient amount of water, that is more than 1% water.

In other words, this method recommends the thermal inhibition of a starch which has been alkalinized beforehand without carrying out a dehydration step.

The starch preparation or the starch is thus brought to a pH comprised between 9.1 and 11.2, preferentially to a value of the order of 10, and the moisture content is adjusted to between 2 and 22%, preferentially between 5 and 10%.

The thermal inhibition is subsequently carried out directly on this powder or this starch, at a temperature comprised between 14° and 190° C., preferentially between 14° and 180° C., for a duration of 30 minutes.

Another alternative has been proposed, contrarily by lowering the pH of the treated starch before thermal inhibition. Indeed, a major drawback is due to the fact that high pH levels tend to increase the browning of the starch during the heating step.

Thus, in patent application WO 2020/139997, a step is described for preparing the starch which successively consists of:
preparing a starch milk,
bringing the starch milk thus prepared to a pH of between 5 and 6.5, by neutralization if necessary,
adding an acidic buffer, and
adjusting the pH.

It is only then the actual heat treatment step is carried out, comprising a dehydration step and a thermal inhibition step.

In this patent application, it is essential to first bring the starch milk to a pH value between 5 and 6.5. Either the starch already has this pH value, considered to be its natural pH value, or a step of “neutralization” (by adding acid or base) to reach this pH range is carried out. This step can take up to 24 hours.

Then a pH buffer of citrate or citric acid is added to bring the pH of the starch milk to a pH value of between 4 and 6. This step may take up to 24 hours more.

Finally, in order to manufacture a thermally inhibited starch, it is taught in this patent application to carry out the dehydration and the thermal inhibition of the starch milk thus treated. This step can take up to 4 hours of reaction time.

Finally, it is established that this method makes it possible to obtain thermally inhibited starches that are whiter and that have improved taste compared to thermally inhibited starches prepared by conventional route, that is to say after alkaline impregnation.

Yet there is still room for improvement in this method for preparing thermally inhibited starches. Indeed, it has the disadvantage, from the point of view of its implemented method, of having to carry out the impregnation of the starch milk in an acid medium only after having finely controlled the initial pH of the starch.

Then, a treatment of this type leads to the production of thermally inhibited starches having a high fixed citrate content, on the order of more than 0.2%, reflecting a significant degree of functionalization.

In the state of the art, other alternatives are presented to improve the thermal inhibition rate of the starch, in order to improve its technological properties.

Thus, in patent EP 1,102,792, it is proposed to dope the starch in the presence of oligosaccharides having 1 to 20 sugar units.

Under certain implementation conditions, the blend of starch and oligosaccharides then develops better stability to cold storage.

However, for certain food applications, heavy purification steps must be added to remove the oligosaccharides from the starch after thermal treatment.

In patent EP 2,251,358, it is preferred to use a powder blend of starch and hemicellulose soluble in water, in particular proportions.

The thermal treatment consists in a heat moisture treatment at a temperature of 100 to 200° C.

It is further recommended to incorporate sodium carbonate (or similar alkaline compounds) with hemicellulose into tapioca, glutinous rice or waxy corn starch.

However, a method for modifying starch is especially sought such that the swelling and/or disintegration (for example, rupture) of the starch granules are effectively suppressed without any chemical treatment.

According to this patent, the aim is not to improve per se the technological properties of the starch thus heat-modified, but to prevent gelatinization of the starch for the manufacture of pastry creams.

There thus remains a need to provide a novel method for preparing heat-modified starches which affords them improved viscosity properties, while retaining their excellent resistance properties, or even making it possible to improve the coloring of the resulting products.

The Applicant company has found that this need could be met by proposing a thermal treatment method for a blend of at least two granular starches of different botanical origins, under acidic conditions.

### DESCRIPTION OF THE INVENTION

According to the invention, the method for preparing a blend of at least two heat-modified starches, in which the starches are granular starches of different botanical origins, comprises the steps consisting in:
(i) preparing a starch milk containing at least two starches of different botanical origins, having total dry matter content comprised between 30 and 40%, and preferably between 35 and 37% by weight,
(ii) preparing a citrate buffer with a pH between 4 and 6, preferably 6, and add said citrate buffer to the starch milk so as to obtain a milk pH between 4 and 6, preferably 6,
(iii) ensuring a contact time comprised between 0.5 and 5 hours,
(iv) drying until reaching an equilibrium moisture content of 10 to 12%,
(v) heating to over 150° C., for a residence time of between 10 minutes and 6 hours,
(vi) resuspending, adjusting the pH, optionally washing and again drying the heat-modified starches thus obtained.

By choosing to blend starches of different botanical origins under acidic conditions before the actual thermal treatment, the Applicant company goes against the teachings of the state of the art.

It is indeed known to produce blends of starches in order to optimize their functional properties, but this is done by blending heat-modified starch varieties with native starches as described in international application WO 2020/018061.

Furthermore, the thermal modification of a blend of starches of different botanical origins makes it possible to ensure the same level of modification of the two (or more) components of the blend.

To the knowledge of the Applicant company, there have been no prior disclosures of thermal treatment methods on a prior blend of at least two starches of different botanical origins, under acidic conditions.

The starches to be used in the method of the invention may be of any origin, for example corn, waxy corn, amylomaize, wheat, waxy wheat, pea, faba bean, potato, waxy potato, tapioca, waxy tapioca, rice, konjac, etc.

Preferentially, it is selected to blend a potato starch with a corn starch, more particularly waxy corn starch (with high amylopectin content).

According to a particular embodiment, the method according to the invention may relate to the preparation of a blend of two heat-modified starches, wherein the starches are granular starches of different botanical origin, present in the blend in equal amounts, thus forming a 50/50 blend by weight.

The method according to the invention requires preparing a starch milk of at least two different botanical origins having total solids content comprised between 30 and 40%, preferably between 35 and 37% by weight. As will be demonstrated by way of examples below, the solid content is set to 36.5% by weight.

The next step is to adjust the pH of the blended starch milk to between 4 and 6, preferably 6.

To do this, it is necessary to prepare a citrate buffer at this pH and add it to the starch milk to obtain a milk pH of between 4 and 6, preferably 6.

A contact time comprised between 0.5 and 5 hours, preferably around 0.5 hours, is then ensured.

After filtration, the preparation is dried at a starch equilibrium moisture between 10 and 12%.

The drying may be carried out at 60° C. in a laboratory Retsch® dryer, but also in a hood with its natural ventilation at room temperature, or in a pilot/industrial dryer, at a temperature of more than 100° C.

After drying at 60° C. and then grinding in a Thermomix® to unclump the starch and avoid the formation of aggregates, the actual heat treatment is carried out.

As will be exemplified below, the heat treatment is carried out at a temperature of 170° C., for a reaction time ranging from 0.5 to 2 hours. This kinetics makes it possible to vary the degree of functionalization of the thermally modified starches thus prepared (the more functionalized the starches are, the stronger the conditions of use, that is to say acidic pH, high shear, high temperature).

However, these conditions can be easily applied to a continuous turbo-dryer or fluidized-bed reaction system.

In a first embodiment of the method according to the invention, the next thermal treatment step itself can be carried out in thermal treatment devices combining the heat exchanges by conduction and by convection, a device of the turbo-dryer type, for example at least one VOMM-type continuous turbo-dryer, which thus makes it possible, depending on the size of said VOMM, to achieve a very short reaction time, of the order of a few minutes, i.e. less than 5 minutes per thermal treatment stage.

The temperature setpoints are then set to values of more than 190° C., preferably comprised between 20° and 210° C., for a residence time comprised between 10 and 60 minutes, even more preferentially between 15 and 35 minutes.

The delta T, defined as the difference in temperature between the setpoint temperature and the temperature of the product at the outlet of the reactor, is between 17 and 27° C.

In a second embodiment of the method according to the invention, the actual thermal treatment can be carried out in devices of the “reaction fluidized bed” type.

As is known to the skilled person, this device consists of a reactor which makes it possible to suspend a divided solid by means of a gas, in this case an air/nitrogen blend. The speed of the gas is adjusted depending on the raw material.

The thermal treatment temperature (temperature of the product) is set at over 130° C., preferably between 13° and 200° C., with a reaction time varying between 30 min and 6 h, preferentially between 2 and 4 hours.

According to a particular embodiment, the present invention relates to a blend of at least two heat-modified starches of distinct botanical origin produced by the method as defined above, characterized in that it has a free citrate content of less than 0.05% and a bound citrate content of between 0.05 and 0.15%.

According to a particular embodiment, the present invention relates to a blend of at least two heat-modified starches as defined above, characterized in that it has a coloring expressed in L* value between 80 and 90, and in YI value between 15 and 20.

The heat-modified starches according to the invention will advantageously be used, based on their respective properties, as a thickening agent or texturizing agent in food applications, especially in soups, sauces, and dairy products.

One of the main limitations of heat-modified starches manufactured from a single botanical source is a developed viscosity slightly lower than that of the commercially available chemically modified starches, requiring overdosing in the event of replacement in the context of a solution that is 100% natural and “with the least possible chemical transformation”. (“clean label”).

These blends are therefore inscribed as a simple and efficient solution for industries that manufacture, for example, sauces.

More particularly, these blends appear to meet the technological requirements for pasteurization, average shear and acidic pH.

The invention will be better understood with the aid of the following examples, which are intended to be illustrative and non-limiting.

### EXAMPLES

### Materials and Methods

The two products used for the pH 6 buffer are below.

| | | | | Mw |
|---|---|---|---|---|
| NAME | | CAS | Raw Formula | (g/mol) |
| 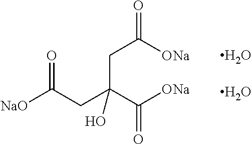 | Sodium citrate tribasic dihydrate | 6132-04-3 | C₆H₅Na₃O₇•2H₂O | 294.1 |
| 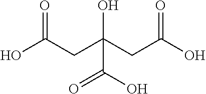 | Citric acid, Anhydrous | 77-92-9 | C₆H₈O₇ | 192.12 |

### Measurement of Conductivity and pH

### Conductivity

The method implemented herein is adapted from the European Pharmacopoeia—current official edition—Conductivity (§ 2.2.38).

### Materials:

KNICK 703 electronic conductivity meter, also equipped with its measuring cell and verified according to the procedure described in its instruction manual.

### Procedure:

A solution containing 20 g of sample in powder form and 80 g of distilled water having a resistivity of greater than 500,000 ohms·cm is prepared.

The measurement is carried out at 20° C. using the conductivity meter, referring to the procedure indicated in the instrument's user manual.

The values are expressed in microSiemens/cm (μS/cm) or milliSiemens/cm (mS/cm).

pH

The method implemented here is adapted from the European Pharmacopoeia—current official edition—pH (§ 2.2.3).

A suspension of the sample to be analyzed at 20% (P/P) is prepared, and the pH value is determined using a laboratory pH meter, referring to the procedure indicated in the machine's manual. The pH is expressed to within 0.01 units.

### Citrate Measurements by HPLC

The citrates are assayed:
directly after heat treatment, on washed and dried products (measurement of free citrates) then,
after hydrolysis (measurement of the fixed citrates) according to the following methods.

### Assay Method

After separation by ion exchange chromatography, the citrate ion is detected by conductimetry. Quantification is done by the internal standard method.

A high-performance liquid chromatography assembly is used for equipment, composed of:
An ICS 2100 Thermofisher system;
A sampler for maintaining samples at 10° C. (TSP AS-AP type);
An AERS 500-ultra suppressor;
A Thermo AS11 HC 250*4 mm column with an AG11-HC 4*50 mm pre-column.
filters for ion chromatography—IC 0.45 μm-Pall.

Use is made, as reagents, of:
HPLC-grade water
Sodium citrate tribasic dihydrate from Sigma
Trifluoroacetic acid from Sigma
Internal standard solution: trifluoroacetic acid solution at 400 mg/L
2N hydrochloric acid from Merck
EGC-KOH cartridge from Thermo.

The procedure is as follows:
Solvent A: HPLC-grade water,
Elution program:

| Time | Flow rate | |
|---|---|---|
| (min) | (mL/min) | KOH |
| 0 | 1.3 | 1.5 |
| 15 | 1.3 | 1.5 |
| 28 | 1.3 | 1.2 |
| 48 | 1.3 | 28 |
| 60 | 1.3 | 40 |
| 60.1 | 1.3 | 60 |
| 67 | 1.3 | 60 |
| 67.1 | 1.3 | 1.5 |
| 77 | 1.3 | 1.5 |

Volume injected: 25 μL
Column temperature: 36° C.
Analysis time: 77 min
Sample temperature: 10° C.
ASRS: 193 mA

### Calibration

Prepare 6 curve points.
Weigh x mg of sodium citrate, that is to say x between 10 and 250 mg and adjust with 500 mL of water. Stir.
Sample 0.5 mL, add 0.5 mL of internal standard and complete to 20 mL with 1 mM sodium hydroxide.
Filter and inject.
Calculate the mass of the chloride standards (weight of sodium chloride (Mw of the ion/Mw of salt).

Draw the calibration curve: ratio of peak heights (=chloride standard weight/internal standard weight).

### Sample

Weigh 100 mg of sample+0.5 mL of internal standard with 20 mL of water.

Filter. Inject.

### Washing and Drying

Approximately 20 g of the sample to be analyzed and 200 mL of demineralized water are introduced into a 250 mL beaker. It is covered with a watch glass and stirred for 20 minutes using a magnetic stirrer. The next step is to filter in a Buchner funnel with a diameter of 150 mm equipped with a white-band Durieux filter #111, with a diameter of 150 mm or equivalent.

The filtrate is placed in a 250 ml beaker, dispersed in 200 ml of demineralized water and stirred for 20 minutes. It is again filtered and rinsed with 200 mL of demineralized water.

The filtered product is dried in a laboratory oven overnight, and then it is ground up to avoid lumps.

### Hydrolysis

In the 250 mL flat-bottomed, ground-neck flask, an accurately weighed test specimen “P” of the sample to be analyzed is introduced. An amount of distilled water equal to (100−P), 100 mL of 2N hydrochloric acid and a few boiling regulators (pumice stone in grains) are added. It is placed in the electromantle with a reflux condenser and left to sit 45 minutes after boiling. It is then cooled and then neutralized with 40% soda solution up to pH 7.

### Expression of Results

The citrate ion content in % is determined by the following equation:

$$Q / P \times 100$$

where:
Q=amount of citrate read on curve (mg)
P=weight of the sample in mg.

Measuring the viscosity of a starch suspension using the Rapid Viscometer Analyzer (RVA)

This measurement is carried out under predetermined concentration conditions and according to a suitable temperature/time analysis profile.

Two buffer solutions are prepared:

### Buffer A

The following are added to a 1 liter beaker containing 500 mL of demineralized water:
91.0 g of citric acid monohydrate (purity>99.5%), and homogenization is carried out,
33.0 g of sodium chloride (purity>99.5%), and homogenization is carried out until complete dissolution,
300.0 g of 1 N sodium hydroxide.

The contents are decanted into a 1 L volumetric flask and demineralized water is added to reach 1 L.

### Buffer B

100 g of buffer A are mixed with 334.0 g of demineralized water.

The product to be analyzed is prepared in the following manner:

A mass of 1.37 g of the dry product to be analyzed, obtained in this way, is directly introduced into the receptacle of the viscometer, and buffer solution B is introduced until a mass equal to 28.00±0.01 g is obtained. Homogenization is carried out using the stirrer blade of the Rapid Visco Analyzer (RVA-NewPort Scientific).

The time/temperature and speed analysis profile in the RVA is then carried out as follows:

TABLE 1

| Time | Temperature | Rotational speed |
|---|---|---|
| hh:mm:ss | ° C. | Revolutions/min (RPM) |
| 00:00:00 | 50 | 100 |
| 00:00:10 | 50 | 500 |
| 00:00:20 | 50 | 960 |
| 00:00:30 | 50 | 160 |
| 00:01:00 | 50 | 160 |
| 00:05:00 | 92 | 160 |
| 00:17:00 | 92 | 160 |
| 00:20:00 | 50 | 160 |

End of test: 00:20:05 (hh:mm:ss)

Initial temperature: 50° C.±0.5° C.

Data acquisition interval: 2 seconds

Sensitivity: low

The results of the measurements are given in RVU (unit used to express the viscosity obtained on the RVA), it being known that 1 RVU unit=12 cPoises (cP).

As a reminder, 1 cP=1 mPa·s.

The results will therefore be presented in mPa·s.

The viscosity measurements will be taken “at the peak”, i.e. the maximum viscosity value between 4 and 6 minutes, and “at the drop”, i.e. the difference between the viscosity value at the peak and that measured at 17 minutes.

### Sedimentation Test

The product is dispersed in an aqueous medium and the settled volume is measured.

### Solution A

Zinc chloride: 10 g
Ammonium chloride: 26 g
Distilled water: qsp 100 mL

In a 250 ml jar, introduce a 1.0 g anhydrous test specimen from the product to be analyzed. Add 100 mL of solution A, cover with cap, homogenize and place in a water bath for 10 min. Cool in a cold water bath, homogenize again, transfer into a 100 mL test tube and measure the settled volume after 24 hours. The settled volume, expressed in mL, is given by the following formula:

settled volume of starch/total volume)×100

It is then considered that a settling volume:
more than 70 ml reflects a slightly functional/weakly resistant product,
between 60 and 70 ml: moderately functional/moderately resistant,
between 40 and 60 ml: highly functional/resistant
less than 40 ml: very highly functional or very resistant

### Color Measurement

The colorimetric measurement is based on the opposite-color theory which specifies that the responses of the cones (the cells of the retina of the human eye responsible for seeing color) to the colors red, green and blue are recombined into opposite signals “black-white”, “red-green” and “yellow-blue” when transmitted to the brain by the optic nerve.

This measurement is based on the color scales widely used in the food and polymer industries, called the CIELAB L*, a*, b* scales.

The L*, a* and b* scales are defined as follows:
axis “L*” (lightness): 0 corresponds to black, 100 corresponds to white
axis “a*” (red-green): the positive values are assigned to red, the negative values are assigned to green; 0 is neutral
axis “b” (yellow-blue): the positive values are assigned to yellow; the negative values are assigned to green; 0 is neutral.

The index “L*” therefore has a value of between 0 and 100, while the indices “b*” and “a*” have no numerical limitations. The measurement apparatus is conventionally a Colorflex® EZ spectrocolorimeter, following the manufacturer's specifications (version of the manual 1.2 of August 2013 for firmware CFEZ version 1.07 and above—see pages 17 and 38).

The measurement is carried out in a 64 mm glass sample cup wherein the sample is inserted so as to fill the glass cup halfway in order to have sufficient material to cover the surface in contact with the rays (for uniformity of measurement).

YI (yellowness index) is a number calculated from spectrophotometric data which describes the change in color of a test sample of “clear or white” to “yellow”, which is well known to the person skilled in the art.

### Example 1: Obtaining the Heat-Modified Starch Blend in a Ventilated Oven

### Preparation of the Base in the Milk Phase:

The 50/50 potato starch+WAXILYS® corn starch blend is suspended in demineralized water with a dry matter content of 36.5%, then citrate buffer is added to obtain a milk pH of 6.

It is then left to stabilize at least 30 min and measure the pH and conductivity of the suspension.

Filtering is carried out on a frit with porosity 3, followed by drying on a RETSCH® type dryer at 60° C. at 10-12% humidity.

It is ground in a Thermomix® mill in order to unclump the starch and avoid the formation of aggregates.

### Heat Treatment

The reaction is carried out at 170° C. in an aluminum dish in a MEMMERT™ type ventilated laboratory oven.

35 to 40 g comp. per aluminum dish (type for METTLER TOLEDO® LJ16 Moisture Measuring Balance) of prepared base is weighed.

The cups are placed in the MEMMERT™ oven previously set to 170° C. Samples are then taken at different times for reaction kinetics analysis.

### Measurements: Humidity, pH, Conductivity, Coloration (L* Nd YI)

TABLE 1

| | | | | | COLORATION | |
|---|---|---|---|---|---|---|
| | | | | | MEASUREMENTS | |
| | | | At 20% DM | | on HunterLab | |
| | PE | Moisture | | Conductivity | COLORFLEX | |
| REF | Hours | % | pH | μS | L* | Yi |
| 043--PREIMPREGNATED BASE | 0 | 10.67 | 6.5 | 346 | 97 | 8 |
| 043 A | 0.5 | 0.09 | 6.4 | 335 | 96 | 9 |
| 043 B | 0.75 | 0.01 | 6.3 | 327 | 94 | 11 |
| 043 C | 1 | 0.01 | 6.3 | 324 | 94 | 12 |
| 043 D | 1.5 | 0.01 | 6.2 | 321 | 92 | 17 |
| 043 E | 2 | 0.01 | 6.0 | 316 | 91 | 20 |

### Resuspension of Products.

After the reaction at 170° C., the sample is resuspended in demineralized water with a moisture content between 30 and 36% dry matter.

The pH is corrected between 5.5 and 6.5 using NaOH.

It is filtered on a frit with porosity 2.

The cake is dried overnight at room temperature in a fume hood and ground (IKA®) to unclump and homogenize the sample.

### Controls: Humidity, pH, Conductivity, Colorations, RVA, Sedimentation Test.

TABLE 2
FILTRATION, DRYING AND GRINDING

| | | MEASUREMENTS AFTER pH ADJUSTMENT, | | | | |
|---|---|---|---|---|---|---|
| | | FILTRATION, DRYING AND GRINDING | | | | |
| | | | | | COLORATION | |
| | | | | | MEASUREMENTS | |
| | | | At 20% DM | | on HunterLab | |
| Washed | PE | Moisture | | Conductivity | COLORFLEX | |
| product | Hours | % | pH | μS | L* | Yi |
| 043 AL | 0.5 | 16.0 | 6.1 | 235 | 97 | 7 |
| 043 BL | 0.75 | 14.7 | 6.1 | 207 | 95 | 10 |
| 043 CL | 1 | 14.7 | 5.6 | 193 | 95 | 10 |
| 043 DL | 1.5 | 15.0 | 5.7 | 173 | 94 | 14 |
| 043 EL | 2 | 13.5 | 5.8 | 173 | 93 | 18 |

Products after washing are obtained whose pH is between 5.5 and 6.5 and whose conductivity is between 170 μS and 235 μS. The colorings in YI (yellow) are between 7 and 18. By comparison, the native corn base has a YI of 8.11.

### Results

RVA viscosity measurements.

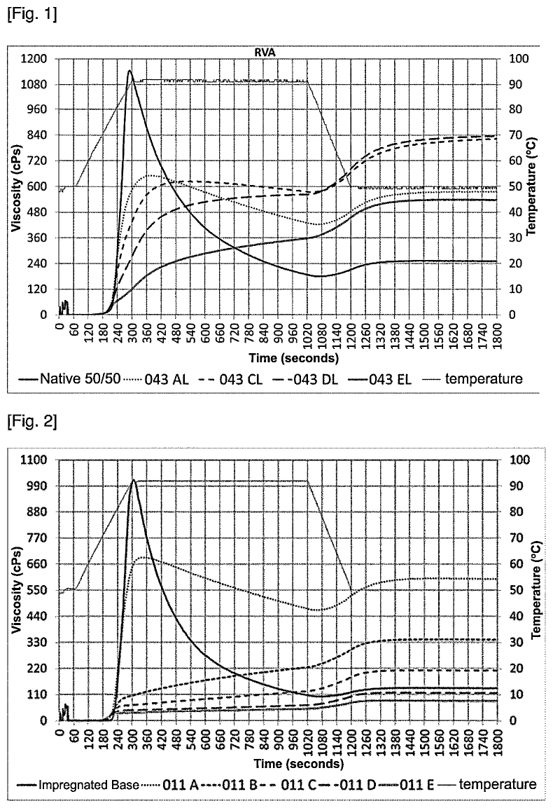

The results are presented in Table 3 and FIG. 1.

TABLE 3

| | | MCL 106H: 1.37 g anh. QSP 28 g buffer B--in cPs | | | | | |
|---|---|---|---|---|---|---|---|
| | | | peak | | | | |
| | | | or max | | | MAX | |
| | | | between | Visco V | | visco | |
| | PE | | 4 and 6 mn | 92° C. + 12′ | fall = | between | V 10′ at |
| REF | Hours | V0 | \textcircled{1} | \textcircled{2} | \textcircled{1} − \textcircled{2} | 4 and 10 | 50° C. |
| Native 50/50 PdT/Waxy | /// | 8.9 | 1145 | 187 | 958 | 1145 | 258 |
| 043--PREIMPREGNATED BASE | 0 | 7.8 | 1066 | 203 | 863 | 1066 | 278 |
| 043 AL | 0.5 | 12.0 | 648 | 430 | 218 | 651 | 587 |
| 043 BL | 0.75 | 6.6 | 574 | 525 | 49 | 607 | 735 |
| 043 CL | 1 | 7.4 | 562 | 576 | −14 | 625 | 830 |
| 043 DL | 1.5 | 7.1 | 394 | 563 | −169 | 529 | 841 |
| 043 EL | 2 | 3.2 | 183 | 357 | −174 | 287 | 539 |

Each blend of heat-modified starches according to the invention has improved stability during the process of use with respect to the native starch: less viscosity gain and retrogradation phenomena are observed during the use of these starches. On this point, it is indeed observed that the more the RVA drop tends towards 0 or becomes negative, the more the product will therefore be functionalized, the more resistant it will be and the less retrogradation it will express.

### Sedimentation Test

TABLE 4

| | REACTION | |
|---|---|---|
| | TIME IN | DECANTATION |
| REF | HOURS | VOLUME ml |
| 043 -- PREIMPREGNATED BASE | 0 | 100 |
| 043 AL | 0.5 | 97 |
| 043 BL | 0.75 | 78 |
| 043 CL | 1 | 73 |
| 043 DL | 1.5 | 53 |
| 043 EL | 2 | 43 |

After 2 h of reaction, a highly functional product is obtained.

### Example 2: Obtaining the Heat-Modified WAXILYS® Corn Starch Blend in a Ventilated Oven

The aim of this experiment is to prepare a heat-modified starch using the same method as in Example 1, but from a single starch source, in this case waxy corn starch, for subsequent comparison with the product made from the blend of waxy corn starch and potato starch according to the invention.

### Preparation of the Base in the Milk Phase

The waxy corn starch (WAXILYS® as marketed by the Applicant company) is introduced into a 1,000 ml beaker, then suspended in demineralized water for a total dry matter (DM) of 36.5% by weight. Sodium citrate and citric acid in powder form are directly added to the starch milk, so as to obtain a pH of 4. It is then left to stabilize at least 30 minutes and measure the pH and conductivity of the suspension. It is filtered on a frit with porosity 3. It is dried on a Retsch® type dryer at 60° C. to an equilibrium moisture level of around 13%. It is ground in a Thermomix® mill in order to unclump the starch and avoid the formation of aggregates.

### Heat Treatment

40 g of sample is weighed and placed in an aluminum cup for a METTLER TOLEDO® LJ16 scale (moisture measurement scale). The cup is inserted into the MEMMERT™ ventilated oven previously heated to 170° C. The chronometer is triggered once the cups have finished going in, and the springs as a function of the chosen reaction kinetics.

Washing and Rectifying the pH of the Products after Reaction by Resuspending

Resuspending the sample at 36% DM in demineralized water, rectifying the pH to between 4.5 and 6.5 using NaOH, filtering through a pore size 3 sinter, and drying the cake overnight at room temperature in a fume hood. Grinding (IKA®) so as to unclump the powder and make the sample powder homogeneous.

Measurements: Humidity, pH, conductivity, coloring (L* and YI), viscosity RVA 4500 on washed products and sedimentation test.

### Results

Physicochemical measurements carried out on final products after washing: moisture, pH, conductivity in μS, coloring. The results are presented in Table 5 below.

TABLE 5

| | | | | | Colorflex ® | |
|---|---|---|---|---|---|---|
| | | | | | Hunter Lab | |
| | Heat | | At 20% DM | | coloration | |
| | treatment | Moisture | | Conductivity | measures | |
| Tests | Hours | % | pH | μS | L* | YI |
| Test 011 A | 0.5 | 15 | 5.5 | 336 | 97.3 | 6.4 |
| Test 011 B | 1 | 14.7 | 5.9 | 176 | 96.9 | 6.9 |
| Test 011 C | 1.5 | 14.8 | 6.2 | 183 | 96.4 | 8.0 |
| Test 011 D | 2 | 14.1 | 4.6 | 203 | 96.1 | 8.5 |
| Test 011 E | 3 | 14.5 | 5.9 | 176 | 95 | 11.7 |

Products after washing are obtained whose pH is between 4.6 and 6.5 and whose conductivity is between 176 μS and 336 μS.

The colorings in YI (yellow) are between 6.4 and 11.7. By comparison, the native Waxy base has a YI of 8.11.

Viscosity analyses—RVA

The results are presented in table 6 below and FIG. 2.

TABLE 6

| | | RVA 4500 at 92° C.-MCL 106H: 1.37 g anh. | | | | | |
|---|---|---|---|---|---|---|---|
| | | QSP 28 g buffer B--in cPs | | | | | |
| | | | peak | | | | |
| | | | or max | | | MAX | |
| | | | between | Visco V | | visco | |
| | PE | | 4 and 6 mn | 92° C. + 12′ | fall = | between | V 10′ at |
| REF | Hours | V0 | \textcircled{1} | \textcircled{2} | \textcircled{1} − \textcircled{2} | 4 and 10 | 50° C. |
| 011--Impregnated base | 0 | 9.7 | 1015 | 107 | 908 | 1015 | 146 |
| 011 A | 0.5 | 5.2 | 689 | 471 | 218 | 689 | 603 |
| 011 B | 1 | 4.3 | 121 | 225 | −104 | 170 | 346 |
| 011 C | 1.5 | 3.9 | 71 | 124 | −53 | 90 | 215 |
| 011 D | 2 | 18.3 | 47 | 66 | −19 | 53 | 135 |
| 011 E | 3 | 11.1 | 36 | 50 | −14 | 42 | 93 |

Each heat-modified starch presented above has improved stability during the process of use with respect to native starch: less viscosity gain and retrogradation are observed when using these starches. On this point, it is indeed observed that the more the RVA drop tends towards 0 or becomes negative, the more the product will therefore be functionalized, the more resistant it will be and the less retrogradation it will express.

### Sedimentation Test

The results are presented in the table below.

TABLE 7

| | Heat | Settling |
|---|---|---|
| | treatment | volume |
| Tests | Hours | mL |
| Waxy corn | 0 | 100 |
| base | | |
| Test 011 A | 0.5 | 82 |
| Test 011 B | 1 | 37 |
| Test 011 C | 1.5 | 22 |
| Test 011 D | 2 | 30 |
| Test 011 E | 3 | 27 |

After 1 hour's reaction, highly functional, i.e. highly resistant, products are obtained.

Comparison of Citrate-Treated Blend with Citrate-Treated Waxy Starch Alone

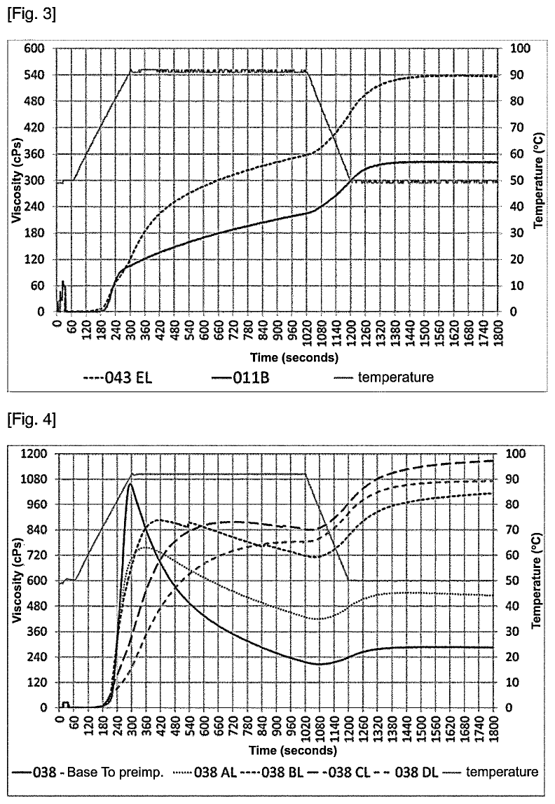

The comparison is easy, by presenting on the same graph the RVA curves of two products with the same level of functionalization (see FIG. 3), in this case the 043 LE blend from Example 1 and the single product 011B.

Thus, for a comparable level of functionalization (i.e. equivalent sedimentation tests), higher viscosity measurements are obtained for the citrate-treated blend.

### Example 3. Obtaining the Heat-Modified Starch Blend in a Ventilated Oven

The preparation of heat-modified starches is conventionally carried out, as mentioned above, by implementing a prior alkaline impregnation step for the starches, rather than an acid treatment as recommended by the Applicant company in the present invention.

The aim of this experiment was to compare the properties of a blend of waxy starch and potato starch pre-treated with these two different methods, at diametrically opposed pH levels.

Preparation of the Blend of Starches and Impregnation with Sodium Carbonate.

The 50/50 blend of WAXILYS® potato starch and corn starch is suspended in demineralized water to a dry matter content of 36.5%.

The pH and the conductivity of the suspension are then measured.

Sodium carbonate is added to this milk under the following alternative conditions:
If sodium carbonate is added in powder form: in a sufficient amount to obtain a final conductivity measured on a powder resuspended to 20% of solids of between 0.5 and 1 mS/cm. A contact time of 2 hours is allowed,
If sodium carbonate is added in solution at 30% weight concentration: in a sufficient amount to obtain a conductivity, on the milk, comprised between 2 and 4 mS/cm. A contact time of 30 minutes is sufficient, given that the sodium carbonate is already dissolved in solution at 30%.

It is filtered and dried at a starch equilibrium moisture of between 10 and 14%.

### Thermal Treatment in an Oven

40 g of sample is weighed and placed in an aluminum cup for a METTLER TOLEDO® LJ16 scale (moisture measurement scale). The cup is inserted into the MEMMERT™ ventilated oven previously heated to 170° C. The chronometer is triggered once the cups have finished going in, and the springs as a function of the chosen reaction kinetics.

### Neutralization and Washing of the Products Obtained

After the reaction at 170° C., the test with 36% solids is resuspended in demineralized water. The pH is corrected to between 5.5 and 6 by HCl.

It is filtered and washed by percolation so as to obtain, on the final product resuspended to 20% of solids, a conductivity <500 μS/cm.

The “cake” obtained is dried under a ventilated hood for one night at ambient temperature.

It is coarsely ground on an IKA® grinder and then sieved through a 315 μm mesh.

Measurements: Humidity, pH, conductivity, coloring (L* and YI), viscosity RVA 4500 on washed products and sedimentation test.

### Results

### Physical/Chemical Measurements:

TABLE 8

| | | MEASUREMENTS AFTER pH | | | | |
|---|---|---|---|---|---|---|
| | | ADJUSTMENT, FILTRATION, | | | | |
| | | DRYING AND GRINDING | | | | |
| | | | At 20% DM | | COLORING | |
| Washed | PE | Moisture | | Conductivity | MEASURES | |
| product | HOURS | % | pH | μS | L* | Yi |
| 038 AL | 0.5 | 12.7 | 6.6 | 26 | 94 | 11 |
| 038 BL | 1 | 13.0 | 6.3 | 31 | 89 | 23 |
| 038 CL | 1.5 | 11.3 | 6.2 | 40 | 86 | 29 |
| 038 DL | 2 | 12.2 | 6.2 | 48 | 85 | 32 |

### Viscosity Analyses—RVA

The results are presented in table 9 below and FIG. 4.

TABLE 9

| | | RVA 4500: 1.37 g anh QSP 28 g buffer B--cPs | | | | | |
|---|---|---|---|---|---|---|---|
| | | | peak | | | | |
| | | | or max | | | MAX | Visco |
| | Reaction | | between | Visco V | | visco | FIN V |
| | time | | 4 and 6 mn | 92° C. + 12′ | fall = | between | 10′ at |
| PE REF | Hours | V0 | \textcircled{1} | \textcircled{2} | \textcircled{1} − \textcircled{2} | 4 and 10 | 50° C. |
| 038 AL | 0.5 | 9.2 | 756 | 428 | 328 | 756 | 539 |
| 038 BL | 1 | 3.3 | 849 | 718 | 131 | 886 | 1017 |
| 038 CL | 1.5 | 1.1 | 550 | 842 | −292 | 861 | 1169 |
| 038 DL | 2 | −0.1 | 342 | 783 | −441 | 678 | 1070 |

Each blend of heat-modified starches according to the invention has improved stability during the process of use with respect to native starch: less viscosity build-up and retrogradation phenomena are observed during the use of these starches. On this point, it is indeed observed that the more the RVA drop tends towards 0 or becomes negative, the more the product will therefore be functionalized, the more resistant it will be and the less retrogradation it will express.

### Sedimentation Test

The results are presented in Table 10 below.

TABLE 10

| | | Sedimentation |
|---|---|---|
| | PE | test MCL 330N |
| REF TESTS | Hour | ml |
| 038 AL | 0.5 | 94 |
| 038 BL | 1 | 67 |
| 038 CL | 1.5 | 51 |
| 038 DL | 2 | 46 |

We can see that after 1 h of reaction we already obtain a moderately functional product and after 1 hour and 30 minutes of reaction and especially after 2 hours we obtain very highly functional products.

Comparison of Citrate-Treated Blend with Carbonate-Treated Blend

The results of this comparison (sedimentation test, coloring and RVA viscosity) can be seen in the following table, based on two blends with the same level of functionalization, in this case the two products obtained after 2 hours of heat treatment.

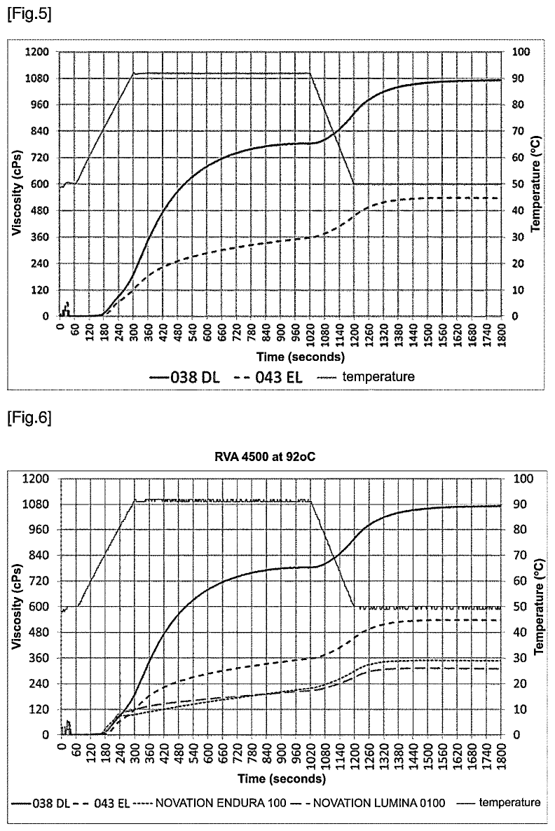

A comparison can be made by plotting the RVA curves of two products with the same level of functionalization (see FIG. 5).

TABLE 11

| | | | | RVA 4500 | | |
|---|---|---|---|---|---|---|
| | | | | peak | | Visco |
| | | Sedimentation | | or max | | FIN V |
| REF | PE | test MCL | Yi | between | | 10′ at |
| TESTS | Hour | 330N ml | Colouring | 4 and 6 mn | fall | 50° C. |
| 038 DL | 2 | 46 | 32 | 342 | −441 | 1070 |
| 043 EL | 2 | 43 | 18 | 183 | −174 | 539 |

The advantage of the citrate treatment method used in this invention is that it produces a product with high functionality and therefore high resistance to process conditions (temperature, acidity, shear), while producing a product with very little color compared to the carbonate treatment process.

Thus, for a comparable level of functionalization (i.e. equivalent sedimentation tests), higher viscosity measurements are obtained for the citrate-treated blend.

### Examples 4: Comparison with Commercial Products in the Same Category

The commercial products presented in this table are produced from a single botanical source, in this case waxy corn starch.

The measurement results are presented in the table below and shown in FIG. 6.

TABLE 12

| | | | | RVA: MCL106H 1.37 g anh | | | |
|---|---|---|---|---|---|---|---|
| | | | | QSP 28 g buffer B | | | |
| | | | | peak | | | |
| | | | SEDIMENTATION | or max | | | CITRATES |
| | COLORING | | TEST | between | | V 10′ at | DOSAGE |
| | L* | Yie | MCL 330N ml | 4 and 6 mn | fall | 50° C. | % dry |
| 038 DL | 85 | 32 | 46 | 342 | −441 | 1070 | /// |
| 043 EL | 93 | 18 | 43 | 183 | −174 | 539 | 0.03 |
| NOVATION ENDURA 100 | 92 | 17 | 43 | 108 | −110 | 354 | 0.10 |
| NOVATION LUMINA 0100 | 95 | 9 | 44 | 136 | −72 | 315 | 0.17 |

It appears that for the same level of resistance (same sedimentation test), the viscosity is higher with products from the invention than with commercial products.

By blending potato starch and waxy corn starch, peak and final viscosities are higher.

The 50/50 blend offers the best compromise between its peak viscosity, which represents the viscosity developed by the product, and its drop viscosity, which represents its level of resistance.

The 50/50 blend makes it possible to benefit from the advantages of the two raw materials in terms of texture, resistance and viscosity development.

1. A method for preparing a blend of at least two heat-modified starches, in which the starches are granular starches of different botanical origins, which comprises the steps consisting in:
(i) preparing a starch milk containing at least two starches of different botanical origins, having total dry matter content comprised between 30 and 40%, and preferably between 35 and 37% by weight,
(ii) preparing a citrate buffer with a pH between 4 and 6, preferably 6, and adding said citrate buffer to the starch milk so as to obtain a milk pH between 4 and 6, preferably 6,
(iii) ensuring a contact time comprised between 0.5 and 5 hours,
(iv) drying until reaching an equilibrium moisture content of 10 to 12%,
(v) heating to over 150° C., for a residence time of between 10 minutes and 6 hours,
(vi) resuspending, adjusting the pH, optionally washing and again drying the heat-modified starches thus obtained.

2. The method according to claim 1, characterized in that the botanical origin of the starches is selected from the group consisting of corn, waxy corn, amylomaize, wheat, waxy wheat, pea, faba bean, potato, waxy potato, tapioca, waxy tapioca, rice, konjac and is more preferentially potato starch and waxy corn starch.

3. The method according to claim 1, characterized in that the rise in temperature of the dry starch obtained in step (iv) is carried out in continuous turbo-dryer type devices, for which the setpoint temperature is set to more than 190° C., preferably between 20° and 210° C., for a residence time comprised between 10 and 60 minutes, even more preferentially between 15 and 35 minutes and the delta T, defined as the difference in temperature between the setpoint temperature and the temperature of the product at the outlet of the reactor, is comprised between 17 and 27° C.

4. The method according to claim 1, characterized in that the rise in temperature of the dry starch obtained in step (iv) is carried out in devices of the reaction fluidized bed type, for which the setpoint temperature is set to more than 130° C., preferably between 13° and 200° C., for a residence time comprised between 30 minutes and 6 hours, even more preferentially between 2 hours and 4 hours.

5. A blend of at least two heat-modified starches of distinct botanical origin produced by the method of any one of the preceding claims, characterized in that it has a free citrate content of less than 0.05% and a bound citrate content of between 0.05 and 0.15%.

6. The blend of at least two heat-modified starches according to claim 1 or 5, characterized in that it has a coloring expressed as an L* value between 80 and 90, and a YI value of between 15 and 20.

7. A use of a heat-modified starch produced by the method according to any one of claims 1 to 4, as a thickening agent or texturizing agent in food applications, in particular in soups and sauces, and in dairy products.
